(19) United States
(12) Patent Application Publication
(10) Pub. No.: US 2023/0126940 A1
(43) Pub. Date: Apr. 27, 2023

(54) BRAKING-ALERTING TRIGGERING DEVICE FOR VEHICLE BRAKE LEVER

(71) Applicant: MEIZHOU FRII LENS ELECTRONIC TECHNOLOGY CO., LTD., Meizhou City (CN)

(72) Inventors: TAU-JENG HSU, Meizhou City (CN); SHUO-YEN HSU, Meizhou City (CN); SHUO-CHIH HSU, Meizhou City (CN)

(21) Appl. No.: 17/681,713

(22) Filed: Feb. 26, 2022

(30) Foreign Application Priority Data
Oct. 25, 2021 (CN) 202111240068.3

(51) Int. Cl. B62J 6/165; B62J 43/30; B62J 43/20; B62L 3/02

(52) U.S. Cl. CPC B62J 6/165; B62J 43/30; B62J 43/20; B62L 3/02; B62J 6/045

(57) ABSTRACT

The present disclosure discloses a braking-alerting triggering device for a vehicle brake lever. The triggering device includes a fastener provided at a brake handle, wherein the fastener is connected to a flexible linking member, and a triggering pushing block is connected to one free end of the flexible linking member; a mounting base is provided on the side of the brake handle, a power-supply module, a micro-controlling module and a wireless-signal emitting module are provided inside the mounting base, and the wireless-signal emitting module is connected to a wireless-signal receiving module inside an external warning light by using a wireless signal; the micro-controlling module is connected to the wireless-signal emitting module; and a triggering switch matching with the triggering pushing block is provided inside the mounting base, and the triggering switch is circuit-connected to the micro-controlling module. The device is used to emit a signal when a vehicle is braking.

### TECHNICAL FIELD

The present disclosure relates to a braking-alerting device, and particularly relates to a braking-alerting triggering device for a vehicle brake lever.

### BACKGROUND

When a bicycle, electric bicycle, tricycle or motorcycle is being ridden through, for example, an urban area that has dense roads, vehicles and population, a safety light that is highly identifiable lacks. Moreover, when those vehicles are being used, a vehicle therebehind has difficulty in clearly knowing the intention of braking of the ahead bicycle, electric bicycle, tricycle or motorcycle, and has difficulty in instantly know and timely react to the braking of the user, which easily causes an accident of rear-end collision of the rear vehicle. Accordingly, the applicant hereby proposes a braking-alerting device that is safe and reliable and can know the intention of braking of the rider in real time. It is found in practical usage that the methods in the prior art, which employ ejector-pin triggering, have the disadvantages such as a complicated structure, a high failure rate, a low reliability and a large difficulty in assembling.

### SUMMARY

An object of the present disclosure is to, aiming at the above-described disadvantages of the prior art, provide a braking-alerting triggering device for a vehicle brake lever that has a compact structure, a high reliability and an excellent usage effect.

The technical solutions of the present disclosure are realized as follows: a braking-alerting triggering device for a vehicle brake lever, comprising a fastener provided at a brake handle, wherein the fastener is connected to a flexible linking member, and a triggering pushing block is connected to one free end of the flexible linking member;

A mounting base is provided at a brake-lever base or a handle bar on a side of the brake handle, a power-supply module, a micro-controlling module and a wireless-signal emitting module are provided inside the mounting base, and the wireless-signal emitting module is connected to a wireless-signal receiving module inside an external warning light by using a wireless signal;

The power-supply module is circuit-connected to the micro-controlling module and the wireless-signal emitting module, and the micro-controlling module is connected to the wireless-signal emitting module;

A triggering switch matching with the triggering pushing block is provided inside the mounting base, and the triggering switch is circuit-connected to the micro-controlling module; and

When the brake handle is being gripped, the flexible linking member drives the triggering pushing block to act, to complete signal triggering.

Optionally, in the above-described braking-alerting triggering device for a vehicle brake lever, the flexible linking member is a tower spring, and the fastener is provided with a stepped hole matching with a larger end of the tower spring; and

A smaller end of the tower spring is fixedly connected to the triggering pushing block by a fastening screw.

Optionally, in the above-described braking-alerting triggering device for a vehicle brake lever, the fastener comprises a brake-handle fixing base of a slot shape, one side wall of the brake-handle fixing base is provided with a first connecting hole, and a silica-gel binding band passes through the first connecting hole;

Positioning groove that matches with the brake handle and extends throughout the silica-gel binding band is integrally formed at one end of the silica-gel binding band that is located inside the brake-handle fixing base, a plurality of positioning holes are provided separately and evenly along the silica-gel binding band in a length direction, and positioning hooks matching with the positioning holes are formed at the other side wall of the brake-handle fixing base that is opposite to the first connecting hole;

The brake-handle fixing base is provided with avoiding not mismatching with and corresponding to the two ends of the extending-throughout positioning groove; and

The stepped hole is disposed at a bottom of an interior of the brake-handle fixing base.

Optionally, in the above-described braking-alerting triggering device for a vehicle brake lever, the mounting base comprises a main base body, an arc-shaped positioning orifice matching with the handle bar is formed at an outer wall of the main base body, an arc-shaped locking strip matching with the arc-shaped positioning orifice is hinged to the main base body at one end of the arc-shaped positioning orifice, and a free end of the arc-shaped locking strip and the main base body are locked and fixed to the handle bar by a locking assembly.

Optionally, in the above-described braking-alerting triggering device for a vehicle brake lever, a sealed chamber is disposed inside the main base body, and all of the power-supply module, the micro-controlling module and the wireless-signal emitting module are located inside the sealed chamber.

Optionally, in the above-described braking-alerting triggering device for a vehicle brake lever, the main base body is formed by two housing covers that match with each other and have symmetrical outer contours; and

a water-proof ring is sandwiched between edges of the two housing covers that are at sides of the arc-shaped positioning orifice, and the water-proof ring and the housing covers cooperate to form the sealed chamber.

Optionally, in the above-described braking-alerting triggering device for a vehicle brake lever, the locking assembly comprises a fisheye screw hinged to the main base body at the other end of the arc-shaped positioning orifice, a second connecting hole is formed near a tip of the free end of the arc-shaped locking strip, and a fastening nut is thread-connected to the fisheye screw on an outer side of the second connecting hole.

Optionally, in the above-described braking-alerting triggering device for a vehicle brake lever, a controlling key is provided on an end face of the mounting base that faces a thumb of a rider, a key controlling module is provided inside the mounting base corresponding to the controlling key, and the key controlling module is circuit-connected to the power-supply module and the micro-controlling module.

Optionally, in the above-described braking-alerting triggering device for a vehicle brake lever, the power-supply module is a button cell, a battery mounting base is provided inside the mounting base, and a battery cover matching with the battery mounting base is provided on a side wall of one side of the mounting base.

Optionally, in the above-described braking-alerting triggering device for a vehicle brake lever, the mounting base is provided with a limiting base, the triggering switch is two triggering clips that are provided separately and are circuit-connected to the micro-controlling module, a limiting base is provided on the mounting base at sides of the triggering clips, a mounting hole that matches with the triggering pushing block and is of a round shape is provided at the limiting base, and the triggering pushing block is movably disposed inside the mounting hole;

The triggering pushing block is of a cylindrical shape, and a spacing ring whose outer diameter is greater than an inner diameter of the mounting hole is provided at a middle part of an outer wall of the triggering pushing block; in an initial state, the two triggering clips do not contact each other; and

When the brake handle is being gripped, the flexible linking member drives the triggering pushing block to move toward the triggering clips, to cause the two triggering clips to contact each other, to complete signal triggering.

In the present disclosure, by using the above-described structure, by providing the flexible linking member and the triggering pushing block between the fastener and the mounting base, when the brake handle is being rotated around the hinging shaft, the fastener rotates along therewith, to drive the flexible linking member to simultaneously be bent and be pushed toward the mounting base, to cause the triggering pushing block to push the two triggering clips to contact, to complete signal triggering. By using the flexible linking member, the present disclosure inventively solves the problem that, in braking, the brake handle simultaneously has two actions of rotation and translation, and has the advantages of sensitive triggering and a high reaction speed.

### BRIEF DESCRIPTION OF THE DRAWINGS

The present disclosure will be described in further detail below with reference to the embodiments in the drawings, which do not function to limit the present disclosure in any form.

FIG. 1 is a schematic structural diagram of the present disclosure;

FIG. 2 is a schematic partially enlarged view at the position A in FIG. 1;

FIG. 3 is a schematic structural diagram of the present disclosure when the housing on one side has been removed;

FIG. 4 is a schematic structural diagram of the interior according to the present disclosure;

FIG. 5 is a schematic partially enlarged view at the position B in FIG. 4;

FIG. 6 is a schematic structural diagram of the flexible linking member according to the present disclosure; and

FIG. 7 is a schematic diagram of the usage state according to the present disclosure.

In the drawings: 1. fastener; 1a. stepped hole; 1b. brake-handle fixing base; 1c. first connecting hole; 1d. silica-gel binding band; 1e. positioning groove; 1f. positioning holes; 1g. positioning hooks; 1h. avoiding notches; 2. flexible linking member; 2a. fastening screw; 3. triggering pushing block; 3a. spacing ring; 4. mounting base; 4a. main base body; 4b. arc-shaped positioning orifice; 4c. arc-shaped locking strip; 4d. locking assembly; 4e. sealed chamber; 4f. water-proof ring; 4g. fisheye screw; 4h. second connecting hole; 4i. fastening nut; 5. power-supply module; 5a. battery cover; 6. micro-controlling module; 7. wireless-signal emitting module; 8. triggering switch; 9. controlling key; 10. key controlling module; 11. limiting base; 12. brake handle; 13. brake-lever base; and 14. handle bar.

### DETAILED DESCRIPTION

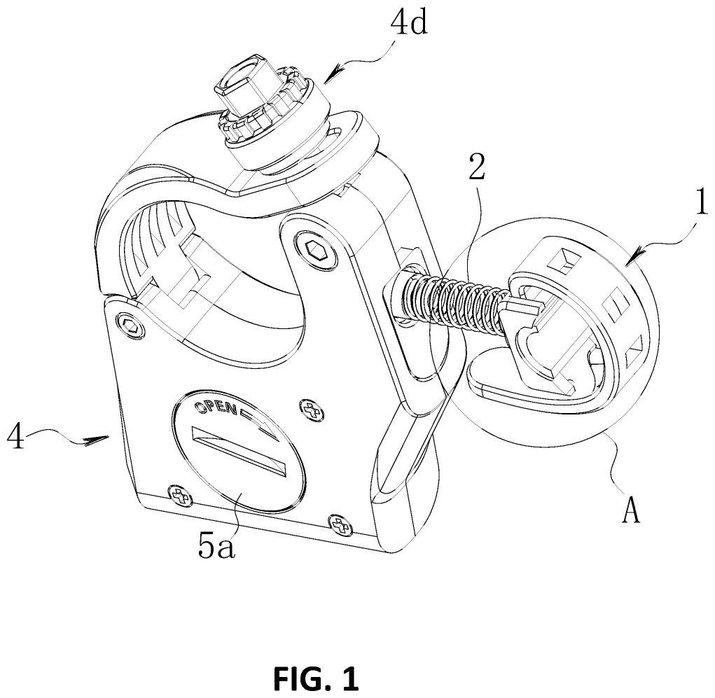

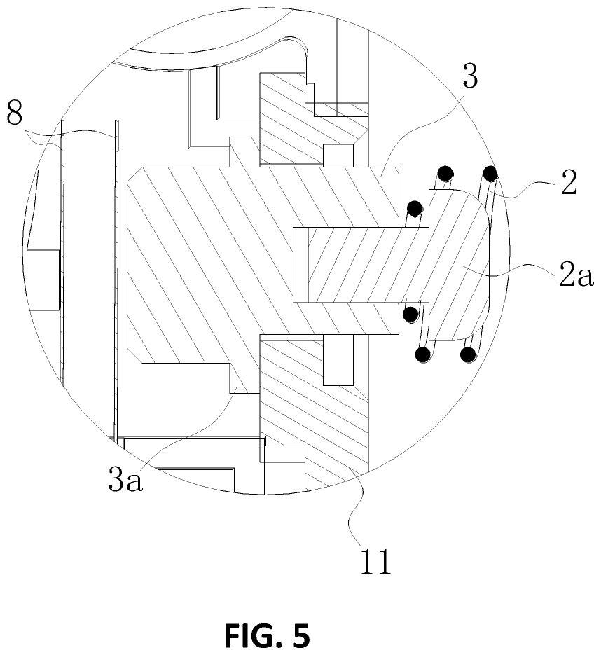

Referring to FIGS. 1 to 5, the braking-alerting triggering device for a vehicle brake lever according to the present disclosure comprises a fastener 1 provided at a brake handle 12, the fastener 1 is connected to a flexible linking member 2, and a triggering pushing block 3 is connected to the free end of the flexible linking member 2. Preferably, the flexible linking member and the fastener are detachably connected, which can facilitate to replace the flexible linking member according to the distances between the handle bar and the brake handle of different vehicle models. If they are fixedly installed, then it is required to, according to the length of the flexible linking member, prepare multiple specifications of the triggering device at the same time.

A mounting base 4 is provided at a brake-lever base 13 or a handle bar 14 on the side of the brake handle, wherein the brake-lever base refers to the component that is hinged to the brake handle and fixed to the handle bar. In the present embodiment, the mounting base is fixed to the handle bar. Certainly, the mounting base may also be fixed to the brake-lever base, whereby it can be designed to be a standard equipped component of the brake handle. It may also be additionally equipped, the advantage of which is that the distance between the mounting base and the brake handle is controllable and the range is relatively constant.

A power-supply module 5, a micro-controlling module 6 and a wireless-signal emitting module 7 are provided inside the mounting base 4, and the wireless-signal emitting module 7 is connected to a wireless-signal receiving module inside an external warning light by using a wireless signal. The power-supply module 5 is circuit-connected to the micro-controlling module 6 and the wireless-signal emitting module 7, and the micro-controlling module 6 is connected to the wireless-signal emitting module 7. The power-supply module, the micro-controlling module and the wireless-signal emitting module may be independently provided or be integrated on the same one PCB board according to particular designing demands. Moreover, the connection mode between and the operation principles of the modules are in the prior art, are not technical keys that the present application seeks to protect, and are not discussed here further.

In the present embodiment, the power-supply module 5 is a button cell, a battery mounting base is provided inside the mounting base 4, and a battery cover 5a matching with the battery mounting base is provided on the side wall of one side of the mounting base 4. Certainly, the power-supply module may also be a rechargeable battery, and accordingly a corresponding charging interface may be provided at the mounting base, which can be easily envisaged by a person skilled in the art.

A triggering switch 8 matching with the triggering pushing block 3 is provided inside the mounting base 4, and the triggering switch 8 is circuit-connected to the micro-controlling module 6. When the brake handle is being gripped, the flexible linking member 2 drives the triggering pushing block 3 to act. In other words, the triggering pushing block triggers the triggering switch, the triggering switch then transmits the signal to the micro-controlling module, the micro-controlling module then transmits the signal to the wireless-signal emitting module, and finally the wireless-signal emitting module emits the signal to complete the signal triggering.

Preferably, the triggering switch 8 is two triggering clips that are provided separately and are circuit-connected to the micro-controlling module 6, a limiting base 11 is provided on the mounting base 4 at the sides of the triggering clips, a mounting hole that matches with the triggering pushing block 3 and is of a round shape is provided at the limiting base 11, and the triggering pushing block 3 is movably disposed inside the mounting hole; and the triggering pushing block 3 is of a cylindrical shape, and a spacing ring 3a whose outer diameter is greater than the inner diameter of the mounting hole is provided at the middle part of the outer wall of the triggering pushing block 3. The spacing ring can prevent pulling-away of the triggering pushing block out of the mounting hole. Moreover, the limiting base is preferably made of an abrasion-resistant metal material or plastic steel material. In addition, the triggering switch may be replaced by a switch commonly used in the art such as a microswitch and a magnetic switch, which can be easily envisaged by a person skilled in the art. Moreover, the circular shapes of the mounting hole and the triggering pushing block are also preferable embodiments, for the purpose of solving the problem of jamming in movement. In theory, by using a polygonal structure having as many as sides, the probability of jamming can also be reduced.

In the initial state, the two triggering clips do not contact each other. When the brake handle is being gripped, the flexible linking member 2 drives the triggering pushing block 3 to move toward the triggering clips, to cause the two triggering clips to contact each other, to complete the signal triggering.

The triggering of the triggering switch by the cooperation between the flexible linking member and the triggering pushing block is a key technical feature of the present application. That effectively solves the problem that, in braking, the brake handle simultaneously has two actions of rotation and translation, and has the advantages of sensitive triggering and a high reaction speed.

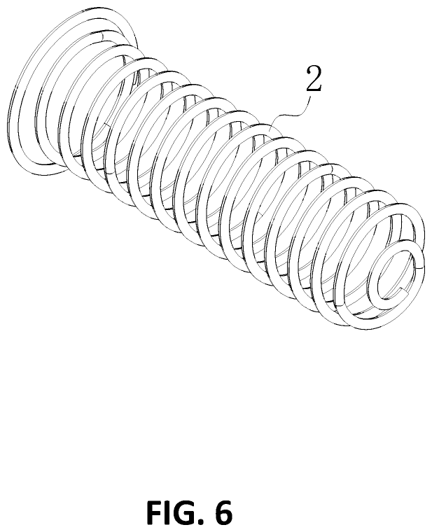

Referring to FIG. 6, preferably, in the present embodiment, the flexible linking member 2 is a tower spring, and the fastener 1 is provided with a stepped hole 1a matching with the larger end of the tower spring; and the smaller end of the tower spring is fixedly connected to the triggering pushing block 3 by a fastening screw 2a. Firstly, the spring as the flexible linking member does not only have a simple structure, but also has a stable operation, a long service life and a low failure rate. Secondly, the tower shape can greatly facilitate the assembling. The larger end, i.e., the bottom end with the largest diameter, may be clipped at the stepped hole, the smaller end, i.e., the top end with the smallest diameter, may be clipped at the fastening screw, and subsequently the triggering pushing block is connected by the fastening screw.

Certainly, a person skilled in the art can easily envisage springs of other shapes or other flexible linking members for alternation, for example plastic materials, such as silica gel or rubber materials resistant to weather. They may also be metals that have the function of memorization and a soft nature, such as an alloy and a thin metal clip. All of those are equivalent alternative solutions.

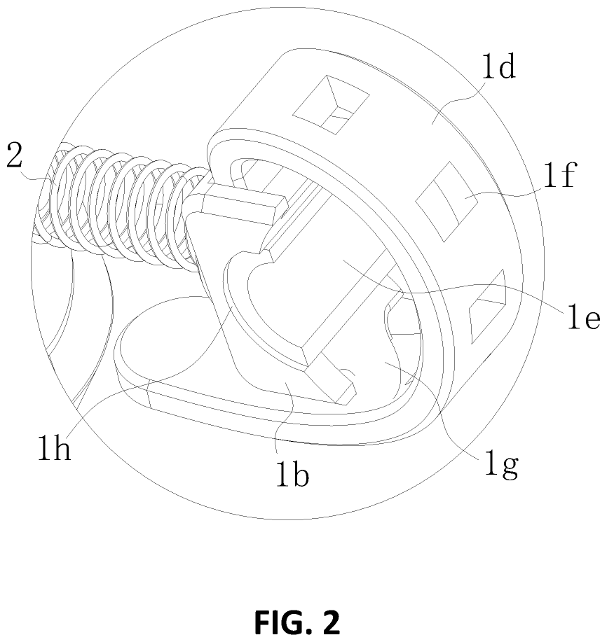

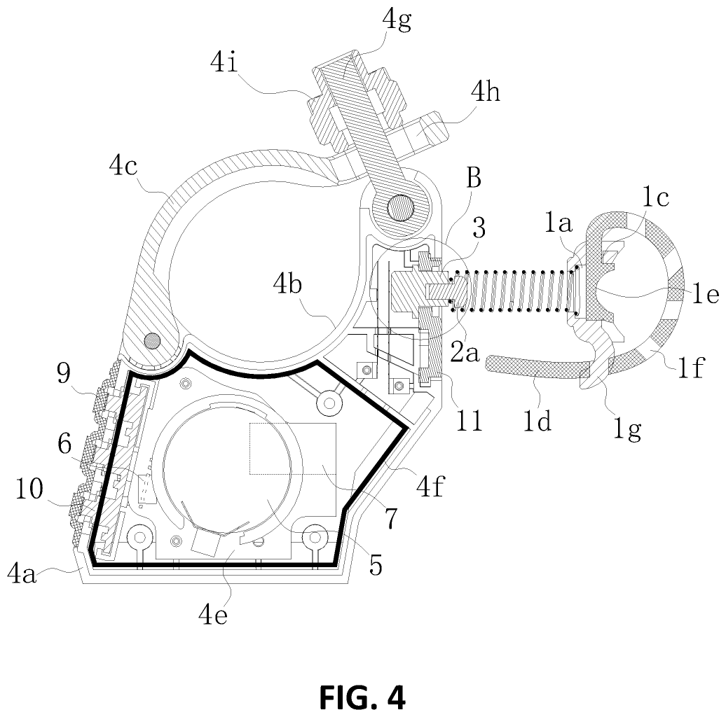

Referring to FIGS. 2 and 4, more preferably, the fastener 1 comprises a brake-handle fixing base 1b of a slot shape, one side wall of the brake-handle fixing base 1b is provided with a first connecting hole 1c, and a silica-gel binding band 1d passes through the first connecting hole 1c.

A positioning groove 1e that matches with the brake handle and extends throughout the silica-gel binding band 1d is integrally formed at one end of the silica-gel binding band 1d that is located inside the brake-handle fixing base 1b, a plurality of positioning holes 1f are provided separately and evenly along the silica-gel binding band 1d in the length direction, and positioning hooks 1g matching with the positioning holes 1f are formed at the other side wall of the brake-handle fixing base 1b that is opposite to the first connecting hole 1c. The brake-handle fixing base 1b is provided with avoiding notches 1h matching with and corresponding to the two ends of the extending-throughout positioning groove 1e. The stepped hole 1a is disposed at the bottom of the interior of the brake-handle fixing base 1b. The fastener of such a structure can be applicable to the brake handle of various specifications, with a high versatility and convenient installation. Moreover, that can artfully prevent the falling of the tower spring at the stepped hole and facilitate the replacement of the tower spring.

Certainly, the fastener may also be replaced by conventional buckles, hoops and so on in the art, which can be easily envisaged by a person skilled in the art.

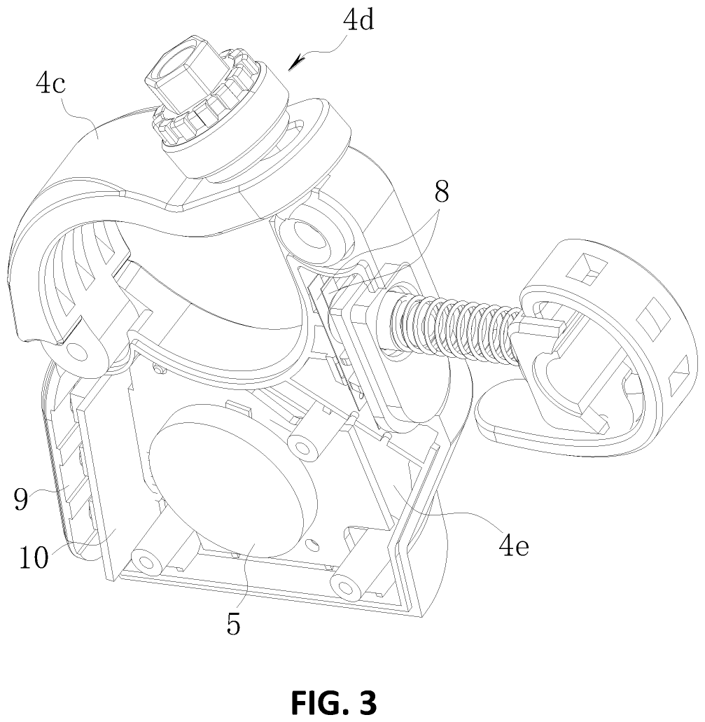

Referring to FIGS. 3 and 4, preferably, the mounting base 4 comprises a main base body 4a, an arc-shaped positioning orifice 4b matching with the handle bar is formed at the outer wall of the main base body 4a, an arc-shaped locking strip 4c matching with the arc-shaped positioning orifice 4b is hinged to the main base body 4a at one end of the arc-shaped positioning orifice 4b, and the free end of the arc-shaped locking strip 4c and the main base body 4a are locked and fixed to the handle bar by a locking assembly 4d.

More preferably, in order to prolong the service lives of the internal electronic elements, a sealed chamber 4e is disposed inside the main base body 4a, and all of the power-supply module 5, the micro-controlling module 6 and the wireless-signal emitting module 7 are located inside the sealed chamber 4e. In the present embodiment, the main base body 4a is formed by two housing covers that match with each other and have symmetrical outer contours. A water-proof ring 4f is sandwiched between the edges of the two housing covers that are at the sides of the arc-shaped positioning orifice 4b, and the water-proof ring 4f and the housing covers cooperate to form the sealed chamber 4e.

In the present embodiment, the locking assembly 4d comprises a fisheye screw 4g hinged to the main base body 4a at the other end of the arc-shaped positioning orifice 4b, a second connecting hole 4h is formed near the tip of the free end of the arc-shaped locking strip 4c, and a fastening nut 4i is thread-connected to the fisheye screw 4g on the outer side of the second connecting hole 4h. Certainly, the locking assembly may also employ the quickly pressed screw commonly used in bicycles to replace the fisheye screw, and, at the same time, correspondingly, the second connecting hole 4h may be accordingly designed to be a bayonet having an opening. Accordingly, in assembling, it is merely required to quickly push the locking screw into the bayonet, and press downwardly the pressed piece hinged to the end of the screw.

More preferably, in order to expand the functions of the product, to enable it to be more humanized and more convenient for usage, a controlling key 9 is provided on the end face of the mounting base 4 that faces the thumb of the rider, a key controlling module 10 is provided inside the mounting base 4 corresponding to the controlling key 9, and the key controlling module 10 is circuit-connected to the power-supply module 5 and the micro-controlling module 6.

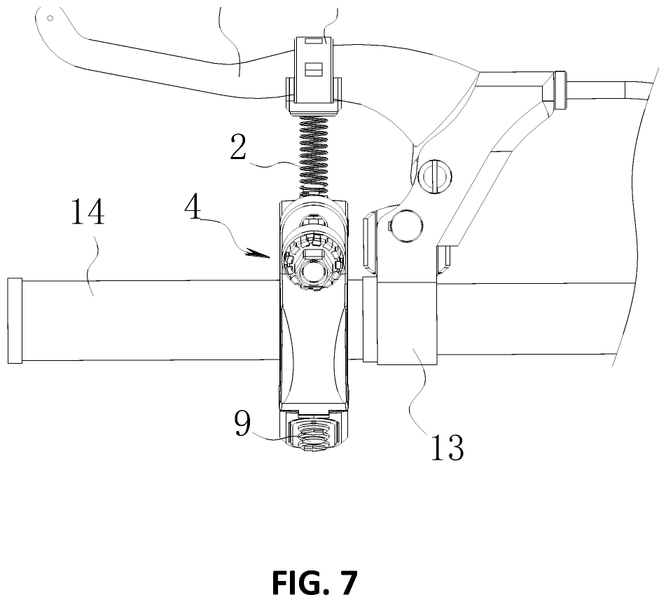

Referring to FIG. 7, in usage, the mounting base is fixed to the end of the connection part between the brake handle and the handle bar that is closer to the hand-held part, then the fastener is nested to the brake handle, then the position of the fastener is adjusted well, which is substantially the side of the brake handle that is closer to the hinged part, and the fastener is locked tightly. Accordingly, the installation of the alerting triggering device is completed. The warning light having the wireless-signal receiving module matching with the alerting triggering device may have multiple shapes and installation positions according to demands, wherein the installation positions may be, for example, the bottom of the vehicle seat, the rear of the vehicle, the back or the side of the rider helmet, the back of the rider, the knapsack of the rider, and so on. In other words, it may be installed at a position where, in braking, the lightened warning light can be seen by a person at the rear or on the sides. According to the different positions, warning lights of different structures, different shapes and different fixing modes are particularly employed, which can be easily envisaged by a person skilled in the art, and is not discussed here further.

The above-described embodiments are preferable embodiments of the present disclosure, are merely intended to facilitate the description on the present disclosure, and are not intended to limit the present disclosure in any form. Any equivalent embodiments that are made by a person skilled in the art by partial alternation or modification to the technical contents disclosed by the present disclosure without departing from the scope of the technical features of the present disclosure fall within the scope of the technical features of the present disclosure.

1. A braking-alerting triggering device for a vehicle brake lever, comprising a fastener (1) provided at a brake handle,
wherein the fastener (1) is connected to a flexible linking member (2), and a triggering pushing block (3) is connected to one free end of the flexible linking member (2);
a mounting base (4) is provided at a brake-lever base or a handle bar on a side of the brake handle, a power-supply module (5), a micro-controlling module (6) and a wireless-signal emitting module (7) are provided inside the mounting base (4), and the wireless-signal emitting module (7) is connected to a wireless-signal receiving module inside an external warning light by using a wireless signal;
the power-supply module (5) is circuit-connected to the micro-controlling module (6) and the wireless-signal emitting module (7), and the micro-controlling module (6) is connected to the wireless-signal emitting module (7);
a triggering switch (8) matching with the triggering pushing block (3) is provided inside the mounting base (4), and the triggering switch (8) is circuit-connected to the micro-controlling module (6); and
when the brake handle is being gripped, the flexible linking member (2) drives the triggering pushing block (3) to act, to complete signal triggering.

2. The braking-alerting triggering device for a vehicle brake lever according to claim 1,
wherein the flexible linking member (2) is a tower spring, and the fastener (1) is provided with a stepped hole (1a) matching with a larger end of the tower spring; and
a smaller end of the tower spring is fixedly connected to the triggering pushing block (3) by a fastening screw (2a).

3. The braking-alerting triggering device for a vehicle brake lever according to claim 2, wherein the fastener (1) comprises a brake-handle fixing base (1b) of a slot shape, one side wall of the brake-handle fixing base (1b) is provided with a first connecting hole (1c), and a silica-gel binding band (1d) passes through the first connecting hole (1c);
a positioning groove (1e) that matches with the brake handle and extends throughout the silica-gel binding band (1d) is integrally formed at one end of the silica-gel binding band (1d) that is located inside the brake-handle fixing base (1b), a plurality of positioning holes (1f) are provided separately and evenly along the silica-gel binding band (1d) in a length direction, and positioning hooks (1g) matching with the positioning holes (1f) are formed at the other side wall of the brake-handle fixing base (1b) that is opposite to the first connecting hole (1c);
the brake-handle fixing base (1b) is provided with avoiding notches (1h) matching with and corresponding to the two ends of the extending-throughout positioning groove (1e); and
the stepped hole (1a) is disposed at a bottom of an interior of the brake-handle fixing base (1b).

4. The braking-alerting triggering device for a vehicle brake lever according to claim 1, wherein the mounting base (4) comprises a main base body (4a), an arc-shaped positioning orifice (4b) matching with the handle bar is formed at an outer wall of the main base body (4a), an arc-shaped locking strip (4c) matching with the arc-shaped positioning orifice (4b) is hinged to the main base body (4a) at one end of the arc-shaped positioning orifice (4b), and a free end of the arc-shaped locking strip (4c) and the main base body (4a) are locked and fixed to the handle bar by a locking assembly (4d).

5. The braking-alerting triggering device for a vehicle brake lever according to claim 4, wherein a sealed chamber (4e) is disposed inside the main base body (4a), and all of the power-supply module (5), the micro-controlling module (6) and the wireless-signal emitting module (7) are located inside the sealed chamber (4e).

6. The braking-alerting triggering device for a vehicle brake lever according to claim 5, wherein the main base body (4a) is formed by two housing covers that match with each other and have symmetrical outer contours; and
a water-proof ring (4f) is sandwiched between edges of the two housing covers that are at sides of the arc-shaped positioning orifice (4b), and the water-proof ring (4f) and the housing covers cooperate to form the sealed chamber (4e).

7. The braking-alerting triggering device for a vehicle brake lever according to claim 4, wherein the locking assembly (4d) comprises a fisheye screw (4g) hinged to the main base body (4a) at the other end of the arc-shaped positioning orifice (4b), a second connecting hole (4h) is formed near a tip of the free end of the arc-shaped locking strip (4c), and a fastening nut (4i) is thread-connected to the fisheye screw (4g) on an outer side of the second connecting hole (4h).

8. The braking-alerting triggering device for a vehicle brake lever according to claim 1, wherein a controlling key (9) is provided on an end face of the mounting base (4) that faces a thumb of a rider, a key controlling module (10) is provided inside the mounting base (4) corresponding to the controlling key (9), and the key controlling module (10) is circuit-connected to the power-supply module (5) and the micro-controlling module (6).

9. The braking-alerting triggering device for a vehicle brake lever according to claim 1, wherein the power-supply module (5) is a button cell, a battery mounting base is provided inside the mounting base (4), and a battery cover (5a) matching with the battery mounting base is provided on a side wall of one side of the mounting base (4).

10. The braking-alerting triggering device for a vehicle brake lever according to claim 1, wherein the triggering switch (8) is two triggering clips that are provided separately and are circuit-connected to the micro-controlling module (6), a limiting base (11) is provided on the mounting base (4) at sides of the triggering clips, a mounting hole that matches with the triggering pushing block (3) and is of a round shape is provided at the limiting base (11), and the triggering pushing block (3) is movably disposed inside the mounting hole;
the triggering pushing block (3) is of a cylindrical shape, and a spacing ring (3a) whose outer diameter is greater than an inner diameter of the mounting hole is provided at a middle part of an outer wall of the triggering pushing block (3);
in an initial state, the two triggering clips do not contact each other; and
when the brake handle is being gripped, the flexible linking member (2) drives the triggering pushing block (3) to move toward the triggering clips, to cause the two triggering clips to contact each other, to complete signal triggering.
